(19) United States
(12) Patent Application Publication
(10) Pub. No.: US 2008/0095897 A1
(43) Pub. Date: Apr. 24, 2008

(54) Processed Meat Products and Methods of Making

(75) Inventors: Jesus Ruben Abril, Westminster, CO (US); Todd Wills, Longmont, CO (US)

Correspondence Address: SHERIDAN ROSS PC, 1560 BROADWAY, SUITE 1200, DENVER, CO, 80202, US

(73) Assignee: MARTEK BIOSCIENCES CORPORATION, Columbia, MD (US)

(21) Appl. No.: 11/832,135

(22) Filed: Aug. 1, 2007

Related U.S. Application Data
(60) Provisional application No. 60/744,572, filed on Aug. 1, 2006.

(51) Int. Cl. A23L 1/31; A23D 7/00; C11B 5/00

(52) U.S. Cl. 426/92; 426/541; 426/545; 426/546; 426/547; 426/608; 426/609

(57) ABSTRACT

Processed meat products and methods of making the same are disclosed. The methods include incorporating a powder-like substance comprising an oil comprising a long chain polyunsaturated fatty acid into a processed meat product.

### CROSS-REFERENCE TO RELATED APPLICATIONS

This application claims the benefit of priority under 35 U.S.C. § 119(e) of U.S. Provisional Application Ser. No. 60/744,572, filed Aug. 1, 2006. The disclosure of this application is incorporated by reference herein in its entirety.

### FIELD OF THE INVENTION

The present invention relates to food products. More particularly, the present invention relates to processed meat products containing long chain polyunsaturated fatty acids.

### BACKGROUND OF THE INVENTION

It is desirable to increase the dietary intake of the beneficial polyunsaturated fatty acids, including omega-3 polyunsaturated fatty acids (PUFA), and omega-3 long chain polyunsaturated fatty acids (LC PUFA). Other beneficial nutrients are omega-6 long chain polyunsaturated fatty acids. As used herein, reference to a long chain polyunsaturated fatty acid or LC PUFA, refers to a polyunsaturated fatty acid having 18 or more carbons. Omega-3 PUFAs are recognized as important dietary compounds for preventing arteriosclerosis and coronary heart disease, for alleviating inflammatory conditions, cognitive impairment and dementia-related diseases and for retarding the growth of tumor cells. One important class of omega-3 PUFAs is omega-3 LC PUFAs. Omega-6 LC-PUFAs serve not only as structural lipids in the human body, but also as precursors for a number of factors in inflammation such as prostaglandins, and leukotrienes.

Fatty acids are carboxylic acids and are classified based on the length and saturation characteristics of the carbon chain. Short chain fatty acids have 2 to about 6 carbons and are typically saturated. Medium chain fatty acids have from about 6 to about 18 carbons and may be saturated or unsaturated. Long chain fatty acids have from 18 to 24 or more carbons and may also be saturated or unsaturated. In longer fatty acids there may be one or more points of unsaturation, giving rise to the terms “monounsaturated” and “polyunsaturated,” respectively. LC PUFAs are of particular interest in the present invention.

LC PUFAs are categorized according to the number and position of double bonds in the fatty acids according to a well understood nomenclature. There are two common series or families of LC PUFAs, depending on the position of the double bond closest to the methyl end of the fatty acid: the ω-3 (or n-3 or omega-3) series contains a double bond at the third carbon, while the ω-6 (or n-6 or omega-6) series has no double bond until the sixth carbon. Thus, docosahexaenoic acid (“DHA”) has a chain length of 22 carbons with 6 double bonds beginning with the third carbon from the methyl end and is designated “22:6 n-3”. Other important LC PUFAs include eicosapentaenoic acid (“EPA”) which is designated “20:5 n-3,” and arachidonic acid (“ARA”) which is designated “20:4 n-6”. Other, less common series or families of LC PUFAs exist, such as ω-9 (or n-9 or omega-9) series which has no double bond until the ninth carbon.

De novo or “new” synthesis of the omega-3 and omega-6 fatty acids such as DHA and ARA does not occur in the human body; however, the body can convert shorter chain fatty acids to LC PUFAs such as DHA and ARA although at very low efficiency. Both omega-3 and omega-6 fatty acids must be part of the nutritional intake since the human body cannot insert double bonds closer to the omega end than the seventh carbon atom counting from that end of the molecule. Thus, all metabolic conversions occur without altering the omega end of the molecule that contains the omega-3 and omega-6 double bonds. Consequently, omega-3 and omega-6 acids are two separate families of essential fatty acids that are not interconvertible in the human body.

Over the past few decades, health experts have recommended diets lower in saturated fats and higher in polyunsaturated fats. While this advice has been followed by a number of consumers, the incidence of heart disease, cancer, diabetes and many other debilitating diseases has continued to increase steadily. Scientists agree that the type and source of polyunsaturated fats is as critical as the total quantity of fats. The most common polyunsaturated fats are derived from vegetable matter and are lacking in long chain fatty acids (most particularly omega-3 LC-PUFAs). In addition, the hydrogenation of polyunsaturated fats to create synthetic fats has contributed to the rise of certain health disorders and exacerbated the deficiency in some essential fatty acids. Indeed, many medical conditions have been identified as benefiting from an omega-3 supplementation. These include acne, allergies, Alzheimer's, arthritis, atherosclerosis, breast cysts, cancer, cystic fibrosis, diabetes, eczema, hypertension, hyperactivity, intestinal disorders, kidney dysfunction, leukemia, and multiple sclerosis. Of note, the World Health Organization has recommended that infant formulas be enriched with omega-3, and omega-6, fatty acids.

The polyunsaturates derived from meat contain significant amounts of omega-6 but little or no omega-3. While omega-6 and omega-3 fatty acids are both necessary for good health, they are preferably consumed in a balance of about 4:1. Today's Western adult diet has created a serious imbalance with current consumption on average of 20 times more omega-6 than omega-3. Concerned consumers have begun to look for health food supplements to restore the equilibrium. Principal sources of omega-3 are flaxseed oil and fish oils. The past decade has seen rapid growth in the production of flaxseed and fish oils. Both types of oil are considered good dietary sources of omega-3 polyunsaturated fats. Flaxseed oil contains no EPA, DHA, or DPA but rather contains linolenic acid—a building block that can be elongated by the body to build longer chain PUFAs. There is evidence, however, that the rate of metabolic conversion can be slow and unsteady, particularly among those with impaired health. Fish oils vary considerably in the type and level of fatty acid composition depending on the particular species and their diets. For example, fish raised by aquaculture tend to have a lower level of omega-3 fatty acids than fish from the wild. In light of the health benefits of such omega-3 and omega-6 LC-PUFAs, it would be desirable to supplement foods with such fatty acids.

Due to the scarcity of sources of omega-3 LC PUFAs, typical home-prepared and convenience foods are low in both omega-3 PUFAs and omega-3 LC PUFAs, such as docosahexaenoic acid, docosapentaenoic acid, and eicosapentaenoic acid. In light of the health benefits of such omega-3 LC PUFAs (chain length 20 and greater), it would be desirable to supplement foods with such fatty acids.

In light of the desirability of supplementing foods with omega-3 LC PUFAs and/or omega-6 LC PUFAs, and in view of the shortcomings of the prior art in providing these foods, there is a need for methods for enriching foods with omega-3 LC PUFAs and/or omega-6 LC PUFAs and also for food oil compositions and food products comprising omega-3 LC PUFAs and/or omega-6 LC PUFAs. These and other needs are answered by the present invention.

### SUMMARY OF THE INVENTION

The present invention is directed toward processed meat products having high contents of LC PUFAs and methods of producing the same. The process of the present invention includes incorporating a powder-like substance comprising an LC PUFA-containing oil into a processed meat product. In this manner, the LC PUFA can be homogeneously dispersed in the meat product reducing stratification of the active ingredient. In some embodiments, the LC PUFA comprises omega-3 LC PUFA and/or omega-6 LC PUFAs. In this manner, the entire product mass can have the active ingredient relatively uniformly distributed therein and reduces variability throughout the product. In addition, the process indirectly stabilizes the oil. The resulting product has acceptable sensory characteristics, acceptable dispersion of the active ingredient in the product and allows for a high recovery of the active ingredient in the food product. The foregoing advantages are achieved in a simple process that, in preferred embodiments, can take advantage of using fillers that are commonly used in the meat industry as part of the powder-like substance.

More particularly, the present invention includes a processed meat product, including comminuted meat products, sectioned and formed meat formulations and sausages, comprising a powder-like substance. The powder-like substance includes an oil comprising a long chain polyunsaturated fatty acid, such as an omega-3 long chain polyunsaturated fatty acid and/or an omega-6 long chain polyunsaturated fatty acid. In preferred embodiments, the powder-like substance also comprises a powder. The powder can be a filler (also known as extender or bulking agent) used in conventional meat product production, such as a starch-based filler or a protein-based filler. Alternatively, the powder can be any suitable flour, such as wheat flour, corn flour, soy flour or chickpea flour. In this embodiment, the powder-like substance is incorporated into the meat product as dispersed particles. In some embodiments, the powder-like substance is a plated oil. In other embodiments, the powder-like substance is a microencapsulated oil. The meat product preferably can be a beef product, a pork product, a poultry product, a seafood product or a meat analog product. The meat product can also include an antioxidant, which preferably can be vitamin E, butylhydroxytoluene (BHT), butylhydroxyanisole (BHA), tert-butylhydroquinone (TBHQ), propyl gallate (PG), vitamin C, a phospholipid, or a natural antioxidant, and in a preferred embodiment is TBHQ. The antioxidant preferably can be present in an amount of between about 0.01% and about 1% by weight of the oil or between about 0.1% and about 0.5% by weight of the oil.

In alternate embodiments, the LC PUFA can be omega-3 LC PUFA or omega-6, such as docosahexaenoic acid, eicosapentaenoic acid, docosapentaenoic acid (n-3), docosapentaenoic acid (n-6) or arachidonic acid. The oil preferably can be from a microbial source, such as a microorganism selected from algae, protists, bacteria or fungi and/or an oleaginous microorganism. The microbial source preferably can be a microorganism selected from microorganisms of the genus Thraustochytrium, microorganisms of the genus Schizochytrium, microorganisms of the genus Althornia, microorganisms of the genus Aplanochytrium, microorganisms of the genus Japonochytrium, microorganisms of the genus Elina, microorganisms of the genus Crypthecodinium, microorganisms of the genus Mortierella and mixtures thereof, and in preferred embodiments is a microorganism from microorganisms of the genus Schizochytrium, microorganisms of the genus Crypthecodinium, microorganisms of the genus Mortierella and mixtures thereof. Alternatively, the oil can be from a plant source, such as a from soybean, corn, safflower, sunflower, canola, flax, peanut, mustard, rapeseed, chickpea, cotton, lentil, white clover, olive, palm, borage, evening primrose, linseed and tobacco. The plants can be either genetically modified to produce long chain polyunsaturated fatty acids or not. The oil can alternatively be from an animal source, such as aquatic animals, animal tissues or animal products. The oil preferably can include at least about 20% omega-3 LC PUFAs and/or omega-6 LC PUFAs or at least about 60% omega-3 LC PUFAs and/or omega-6 LC PUFAs.

The dispersed particles preferably can include greater than about 50% by weight powder and less than about 50% by weight of the oil. Alternatively, the dispersed particles can include between about 50% by weight and about 90% by weight powder and between about 10% by weight and about 50% by weight oil, between about 55% by weight and about 80% by weight powder and between about 20% by weight and about 45% by weight oil, or between about 60% by weight and about 70% by weight powder and between about 30% by weight and about 40% by weight oil.

The processed meat product preferably can include from about 5 mg to about 150 mg LC PUFA per serving of the meat product.

Another embodiment of the invention is a process for preparing a processed meat product. The process includes combining an oil comprising a long chain polyunsaturated fatty acid, preferably selected from an omega-3 long chain polyunsaturated fatty acid, an omega-6 long chain polyunsaturated fatty acid and mixtures thereof with a powder to form a powder-like substance. The powder-like substance is then incorporated into a processed meat product.

### BRIEF DESCRIPTION OF THE FIGURES

FIG. 1 shows a sensory evaluation of beef frankfurters. Legend: left-most bar to rightmost bar: control, product containing 50 mg DHA (from DHA-containing clear oil)/45 gram serving, product containing 100 mg DHA (from DHA-containing clear oil)/45 gram serving, product containing 100 mg DHA (from DHA-containing semi-solid oil)/45 gram serving.

FIG. 2 shows a sensory evaluation of chicken nuggets. Legend: left-most bar to rightmost bar: control, product containing DHA (from DHA-containing semi-solid oil), DHA (from DHA-containing clear oil). T0 and T1 have no control bar.

FIG. 3A shows a sensory evaluation of ham loaf (ham loaf control). Legend: left-most bar to rightmost bar: product containing 50 mg DHA (from DHA-containing semi-solid oil), product containing 100 mg DHA (from DHA-containing semi-solid oil).

FIG. 3B shows a sensory evaluation of ham loaf (sliced ham control). Legend: left-most bar to rightmost bar: product containing 50 mg DHA (from DHA-containing semi-solid oil), product containing 100 mg DHA (from DHA-containing semi-solid oil).

FIG. 4 shows analytical recovery of DHA in beef frankfurters. Legend: left bar: target, right bar: actual recovery.

FIG. 5 shows analytical recovery of DHA in chicken nuggets. Legend: left bar to right bar: target recovery, pre-cook recovery, post cook recovery, six months frozen storage recovery.

FIG. 6 shows analytical recovery of DHA in ham loaf. Legend: left bar: target, right bar: actual recovery

### DETAILED DESCRIPTION OF THE INVENTION

The present invention includes meat products and methods for producing the same that enhance the LC PUFA content of meat products and provide for increased intake of LC PUFAs. In some embodiments, the LC PUFA comprises omega-3 LC PUFA and/or omega-6 LC PUFAs. This improvement can provide health benefits to those consuming such products. The present invention also provides methods to minimize the oxidative degradation of LC PUFAs in the food products of the present invention.

In various embodiments, the present invention is directed toward processed meat products having high contents of LC PUFAs and methods of producing the same. The process of the present invention includes incorporating a powder-like substance that comprises an oil comprising an LC PUFA in the process for producing a processed meat product. The powder-like substance can be produced by blending an oil comprising an LC PUFA with a powder. Alternatively, the powder-like substance can be a microencapsulated oil. In this manner, the LC PUFA can be homogeneously dispersed in the meat product preventing stratification of the active ingredient (i.e., the LC PUFA). This process can result in the product mass having the same amount of active ingredient uniformly distributed therein and reduces variability throughout the product. In addition, the process indirectly stabilizes the oil.

In some embodiments, the oils of the present invention comprise an omega-3 LC PUFA and/or omega-6 LC PUFA. Preferred omega-3 LC PUFAs include, for example, docosahexaenoic acid C22:6(n-3) (DHA), eicosapentaenoic acid C20:5(n-3)(EPA), and omega-3 docosapentaenoic acid C22:5(n-3) (DPA). DHA is particularly preferred. Preferred omega-6 LC-PUFAs include gamma linolenic acid (GLA), linoleic acid (LA), omega-6 docosapentaenoic acid C22:5(n-6) (DPA) and arachidonic acid (ARA). The PUFAs preferably can be in any of the common forms found in natural lipids including but not limited to triacylglycerols, diacylglycerols, monoacylglycerols, phospholipids, free fatty acids, esterified fatty acids, or in natural or synthetic derivative forms of these fatty acids (e.g. calcium salts of fatty acids, ethyl esters, etc). Reference to an oil comprising an omega-3 LC PUFA and/or omega-6 LC PUFA, as used in the present invention, can refer to either an oil comprising only a single omega-3 LC PUFA and/or omega-6 LC PUFA such as DHA or an oil comprising a mixture of omega-3 LC PUFAs and/or omega-6 LC PUFA such as DHA and EPA, or DHA and ARA.

A preferred source of oils that comprise LC PUFAs, in the compositions and methods of the present invention includes a microbial source. Microbial sources and methods for growing microorganisms comprising nutrients and/or LC PUFAs are known in the art (Industrial Microbiology and Biotechnology, 2^{nd} edition, 1999, American Society for Microbiology). Preferably, the microorganisms are cultured in a fermentation medium in a fermentor. The methods and compositions of the present invention are applicable to any industrial microorganism that produces any kind of nutrient or desired component such as, for example algae, protists, bacteria and fungi (including yeast).

Microbial sources preferably can include microorganisms such as algae, bacteria, fungi and/or protists. Preferred organisms include those selected from the group consisting of golden algae (such as microorganisms of the kingdom Stramenopiles), green algae, diatoms, dinoflagellates (such as microorganisms of the order Dinophyceae including members of the genus Crypthecodinium such as, for example, Crypthecodinium cohnii), yeast, and fungi of the genera Mucor and Mortierella, including but not limited to Mortierella alpina and Mortierella sect. schmuckeri. Members of the microbial group Stramenopiles include microalgae and algae-like microorganisms, including the following groups of microorganisms: Hamatores, Proteromonads, Opalines, Develpayella, Diplophrys, Labrinthulids, Thraustochytrids, Biosecids, Oomycetes, Hypochytridiomycetes, Commation, Reticulosphaera, Pelagomonas, Pelagococcus, Ollicola, Aureococcus, Parmales, Diatoms, Xanthophytes, Phaeophytes (brown algae), Eustigmatophytes, Raphidophytes, Synurids, Axodines (including Rhizochromulinaales, Pedinellales, Dictyochales), Chrysomeridales, Sarcinochrysidales, Hydrurales, Hibberdiales, and Chromulinales. This detailed description of the invention will discuss processes for growing microorganisms which are capable of producing lipids comprising omega-3 and/or omega-6 polyunsaturated fatty acids, in particular microorganisms that are capable of producing DHA (or closely related compounds such as DPA, EPA or ARA). Additional preferred microorganisms, especially for producing DHA and DPA, are algae, such as Thraustochytrids of the order Thraustochytriales, more specifically Thraustochytriales, including Thraustochytrium, Schizochytrium and Ulkenia, and including Thraustochytriales which are disclosed in commonly assigned U.S. Pat. Nos. 5,340,594 and 5,340,742, both issued to Barclay, all of which are incorporated herein by reference in their entirety, in addition to microorganisms of the genus Althornia, genus Aplanochytrium, genus Japonochytrium, and genus Elina and mixtures thereof. More preferably, the microorganisms are selected from the group consisting of microorganisms having the identifying characteristics of ATCC number 20888, ATCC number 20889, ATCC number 20890, ATCC number 20891 and ATCC number 20892, strains of Mortierella schmuckeri (e.g., including ATCC 74371) and Mortierella alpina (especially for producing ARA), strains of Crypthecodinium cohnii (especially for producing DHA), mutant strains derived from any of the foregoing, and mixtures thereof. Also preferred are strains of Crypthecodinium cohnii, including microorganisms having the identifying characteristics of ATCC Nos. 30021, 30334-30348, 30541-30543, 30555-30557, 30571, 30572, 30772-30775, 30812, 40750, 50050-50060, and 50297-50300. It should be noted that many experts agree that Ulkenia is not a separate genus from the genus Thraustochytrium. Accordingly, as used herein, the genus Thraustochytrium will include Ulkenia. Oleaginous microorganisms are also preferred. As used herein, “oleaginous microorganisms” are defined as microorganisms capable of accumulating greater than 20% of the weight of their cells in the form of lipids. Genetically modified microorganisms that produce LC PUFAs are also suitable for the present invention. These preferably can include naturally LC PUFA-producing microorganisms that have been genetically modified as well as microorganisms that do not naturally produce LC PUFAs (including yeast, bacteria, fungi, algae and/or protists) but that have been genetically engineered to do so.

Suitable organisms may be obtained from a number of available sources, including by collection from the natural environment. For example, the American Type Culture Collection currently lists many publicly available strains of microorganisms identified above. As used herein, any organism, or any specific type of organism, includes wild strains, mutants, or recombinant types. Growth conditions in which to culture or grow these organisms are known in the art, and appropriate growth conditions for at least some of these organisms are disclosed in, for example, U.S. Pat. No. 5,130,242, U.S. Pat. No. 5,407,957, U.S. Pat. No. 5,397,591, U.S. Pat. No. 5,492,938, and U.S. Pat. No. 5,711,983, all of which are incorporated herein by reference in their entirety.

Another preferred source of oils comprising LC PUFAs includes a plant source, such as oilseed plants. Since plants do not naturally produce LC PUFAs of 20 carbons or longer, plants producing LC PUFAs preferably are those genetically engineered to express genes that produce LC PUFAs. Such genes preferably can include genes encoding proteins involved in the classical fatty acid synthase pathways, or genes encoding proteins involved in the PUFA polyketide synthase (PKS) pathway. The genes and proteins involved in the classical fatty acid synthase pathways, and genetically modified organisms, such as plants, transformed with such genes, are described, for example, in Napier and Sayanova, Proceedings of the Nutrition Society (2005), 64:387-393; Robert et al., Functional Plant Biology (2005) 32:473-479; or U.S. Patent Application Publication 2004/0172682. The PUFA PKS pathway, genes and proteins included in this pathway, and genetically modified microorganisms and plants transformed with such genes for the expression and production of PUFAs are described in detail in: U.S. Pat. No. 6,566,583; U.S. Pat. No. 7,247,461, U.S. Pat. No. 7,211,418, and U.S. Pat. No. 7,217,856, each of which is incorporated herein by reference in its entirety.

Preferred oilseed crops include soybeans, corn, safflower, sunflower, canola, flax, peanut, mustard, rapeseed, chickpea, cotton, lentil, white clover, olive, palm oil, borage, evening primrose, linseed, and tobacco that have been genetically modified to produce LC PUFA as described above.

Genetic transformation techniques for microorganisms and plants are well-known in the art. Transformation techniques for microorganisms are well known in the art and are discussed, for example, in Sambrook et al., 1989, Molecular Cloning: A Laboratory Manual, Cold Spring Harbor Labs Press. A general technique for transformation of dinoflagellates, which can be adapted for use with Crypthecodinium cohnii, is described in detail in Lohuis and Miller, The Plant Journal (1998) 13(3): 427-435. A general technique for genetic transformation of Thraustochytrids is described in detail in U.S. Patent Application Publication No. 20030166207, published Sep. 4, 2003. Methods for the genetic engineering of plants are also well known in the art. For instance, numerous methods for plant transformation have been developed, including biological and physical transformation protocols. See, for example, Miki et al., “Procedures for Introducing Foreign DNA into Plants” in Methods in Plant Molecular Biology and Biotechnology, Glick, B. R. and Thompson, J. E. Eds. (CRC Press, Inc., Boca Raton, 1993) pp. 67-88. In addition, vectors and in vitro culture methods for plant cell or tissue transformation and regeneration of plants are available. See, for example, Gruber et al., “Vectors for Plant Transformation” in Methods in Plant Molecular Biology and Biotechnology, Glick, B. R. and Thompson, J. E. Eds. (CRC Press, Inc., Boca Raton, 1993) pp. 89-119. See also, Horsch et al., Science 227:1229 (1985); Kado, C. I., Crit. Rev. Plant. Sci. 10:1 (1991); Moloney et al., Plant Cell Reports 8:238 (1989); U.S. Pat. No. 4,940,838; U.S. Pat. No. 5,464,763; Sanford et al., Part. Sci. Technol. 5:27 (1987); Sanford, J. C., Trends Biotech. 6:299 (1988); Sanford, J. C., Physiol. Plant 79:206 (1990); Klein et al., Biotechnology 10:268 (1992); Zhang et al., Bio/Technology 9:996 (1991); Deshayes et al., EMBO J., 4:2731 (1985); Christou et al., Proc Natl. Acad. Sci. USA 84:3962 (1987); Hain et al., Mol. Gen. Genet. 199:161 (1985); Draper et al., Plant Cell Physiol. 23:451 (1982); Donn et al., In Abstracts of VIth International Congress on Plant Cell and Tissue Culture IAPTC, A2-38, p. 53 (1990); D'Halluin et al., Plant Cell 4:1495-1505 (1992) and Spencer et al., Plant Mol. Biol. 24:51-61 (1994).

When oilseed plants are the source of LC PUFAs, the seeds preferably can be harvested and processed to remove any impurities, debris or indigestible portions from the harvested seeds. Processing steps vary depending on the type of oilseed and are known in the art. Processing steps preferably can include threshing (such as, for example, when soybean seeds are separated from the pods), dehulling (removing the dry outer covering, or husk, of a fruit, seed, or nut), drying, cleaning, grinding, milling and flaking. After the seeds have been processed to remove any impurities, debris or indigestible materials, they can be added to an aqueous solution preferably water, and then mixed to produce a slurry. Preferably, milling, crushing or flaking is performed prior to mixing with water. A slurry produced in this manner preferably can be treated and processed the same way as described for a microbial fermentation broth. Size reduction, heat treatment, pH adjustment, pasteurization and other known treatments preferably can be used in order to improve quality (nutritional and sensory).

Another preferred source of oils that comprise LC PUFAs includes an animal source. Examples of animal sources include aquatic animals (e.g., fish, marine mammals, and crustaceans such as krill and other euphausids) and animal tissues (e.g., brain, liver, eyes, etc.) and animal products such as eggs or milk. Techniques for recovery of LC PUFA containing oils from such sources are known in the art.

Preferably, the oil comprises at least about 20% of omega-3 LC PUFA and/or omega-6 LC PUFA, at least about 30% of omega-3 LC PUFA and/or omega-6 LC PUFA, at least about 40% of omega-3 LC PUFA and/or omega-6 LC PUFA, at least about 50% of omega-3 LC PUFA and/or omega-6 LC PUFA, at least about 60% of omega-3 LC PUFA and/or omega-6 LC PUFA, 70% of omega-3 LC PUFA and/or omega-6 LC PUFA, and at least about 80% of omega-3 LC PUFA and/or omega-6 LC PUFA.

As described above, the powder-like substance can be produced by combining an oil comprising an LC PUFA with a powder to form a powder-like substance. As used herein, the terms “powder” and “powder-like substance” refers to particulate materials that are flowable. In various embodiments, the particulate materials have a mean particle size of between about 50μ and about 500μ, between about 75μ and about 325μ, and between about 100μ and about 150μ. In preferred embodiments, the powder can be materials commonly used in the meat processing industry that are typically polymeric and are commonly referred to as “fillers,” “extenders,” or “bulking agents,” and equivalent materials. Such materials preferably can include starch-based materials, such as corn starch, potato starch or derivatives thereof, such as corn syrup solids and maltodextrin. Such materials preferably can also include protein-based materials such as whey protein, soy protein and derivatives thereof. Any filler suitable for conventional processed meats is suitable for the present invention.

In the process of combining the oil with a powder to form a powder-like substance, the oil is “plated” on the powder, and the resulting dispersed particles containing oil and filler, that make up the powder-like substance, can be readily introduced to processed meat products and be dispersed throughout the products. The powder-like substance preferably can be pre-made to desired specifications and stored prior to the step of preparing processed meat products.

The powder-like substance of the present invention preferably can include any suitable ratio of the oil and powder that results in a powder-like substance that can be dispersed in a processed meat product. Typically, the dispersed particles will comprise greater than about 50% by weight powder and less than about 50% by weight oil. In preferred embodiments, the dispersed particles will comprise between about 50% by weight and about 90% by weight powder, between about 55% by weight and about 80% by weight powder, and between about 60% by weight and about 70% by weight powder. In preferred embodiments, the dispersed particles will comprise between about 10% by weight and about 50% by weight oil, between about 20% by weight and about 45% by weight oil, and between about 30% by weight and about 40% by weight oil.

The process of combining an oil comprising an LC PUFA with a powder to form a powder-like substance includes combining the components and mixing to form a material that is uniform in appearance. Such mixing preferably can be done in a suitable vessel using known mixing equipment such as a paddle mixer, a ribbon mixer or an impeller. The order of mixing is not important, but typically, a powder is added to the oil, with mixing, until the combined material is a uniform powder-like substance. Without being bound by theory, it is believed that during the mixing process, the oil is absorbed by the powder.

Without intending to be bound by theory, the formation of the powder-like substance of the present invention is believed to provide a stabilizing effect on the oil PUFAs, reducing the likelihood and/or the extent of oxidative degradation that the PUFAs would otherwise undergo. In the specific embodiment in which the powder is a conventional meat filler, the advantage of obtaining a stabilizing effect on the oil is achieved without the need to incorporate additional components to the meat product.

In some embodiments, the powder-like substance is a microencapsulated oil. Microencapsulation of a liquid, such as an oil, allows the formation of a particle that presents a dry outer surface with an entrained oil, such that the particles are a free-flowing powder. Microencapsulation therefore effectively enables the conversion of liquids to powders. Microcapsules comprise roughly spherical particles that contain an encapsulated (entrapped) substance. The particle usually has some type of shell, often a polymeric shell, such as a polypeptide or polysaccharide shell, and the encapsulated active product is located within the shell.

Numerous techniques for microencapsulation are known depending on the nature of the encapsulated substance and on the type of shell material used. Methods typically involve solidifying emulsified liquid droplets by changing temperature, evaporating solvent, or adding chemical cross-linking agents. Such methods include, for example, spray drying, interfacial polymerization, hot melt encapsulation, phase separation encapsulation (solvent removal and solvent evaporation), spontaneous emulsion, solvent evaporation microencapsulation, solvent removal microencapsulation, coacervation, and low temperature microsphere formation and phase inversion nanoencapsulation (PIN). Microencapsulation is suitable for LC PUFAs and LC PUFA-containing oils.

Microencapsulated LC PUFA-containing oils can be prepared by any method known in the art. For example, such oils can be spray-dried. Other methods for encapsulation are known, such as fluid bed drying, drum (film) drying, coacervation, interfacial polymerization, fluid bed processing, pan coating, spray gelation, ribbon blending, spinning disk, centrifugal coextrusion, inclusion complexation, emulsion stabilization, spray coating, extrusion, liposome nanoencapsulation, supercritical fluid microencapsulation, suspension polymerization, cold dehydration processes, evaporative dispersion processes, and methods that take advantage of differential solubility of coatings at varying temperatures.

The field of preparing processed meat products is well developed and the process of the present invention includes the novel incorporation of the particulate compositions described herein to processed meat products. A description of processed meat technology, including formulations and product preparation processing is, for example, contained in “Processed Meats” Second Edition by A. M. Pearson and F. W. Taiber, Avi Publishing Company, Inc., Westport, Conn. The term “processed meat products” is used herein conventionally to refer to a wide variety of meat and meat analog based food products. The term “processed meat products” is intended to embrace both 1) sectioned and formed meat formulations, sometimes referred to as “luncheon meats” e.g., ham loaf, turkey loaf or roll, etc., 2) sausages of all types, and 3) comminuted meat, and comminuted meat mixtures. Sausages generally include 1) ordinary or ground sausage, 2) semi dry or summer sausage, 3) dry or hard sausage, and 4) emulsion sausages such as bologna. Both summer sausage and dry sausages are fermented products. Examples of processed meats include water-added ham products, bologna, hot dogs, franks, chicken patties, chicken nuggets, beef patties, fish patties, surimi, bacon, luncheon meat, sandwich fillings, deli meats, meat snacks, meatballs, jerky, fajitas, bacon bits, injected meats, and bratwurst. The food products provided herein are for illustrative purposes only and are not meant to be an exhaustive list. Comminuted meat, and comminuted meat mixtures include meat muscle which has been interrupted from its natural form such as by cutting, shredding, chopping, grinding, emulsifying and the like. Comminuted meat may include ground meat such as ground beef (hamburger), ground turkey, ground chicken, and the like. Appropriate particle sizes for products such as patties and sausages are well known to the skilled artisan. Such comminuted meat can be subsequently prepared as, for example, hamburger, sloppy joes and taco filling meat.

Processed meat products, however, are to be distinguished from merely various meat cuts obtained by conventional butchering.

In the preparation of processed meat products, the meat(s) must be reduced in size, the meat pieces admixed with other ingredients, e.g., to form a meat dough, the mix formed into desired shapes or sizes, and a gel formed or allowed to set. A very wide variety of variations in these steps is practiced depending on such factors as meat sources, whether gelling agents or adjuvants are employed, and the type of product desired. Additionally, a variety of optional additional steps can also be practiced including, for example, fermenting, curing, smoking, drying and cooking. The steps can be practiced in varying orders as well.

A meat or meat characterizing ingredient(s) is the first major constituent of the present processed meat products. Exemplary meat characterizing ingredients can include all conventional meats including primarily beef, pork, poultry (e.g., chicken and turkey), seafood (e.g., fish and crustaceans), venison, veal and mixtures thereof. Other meat characterizing ingredients useful in processed meat products include meat substitutes or meat analog materials, such as products made from soy derivatives, beans, legumes, mushrooms, and other vegetarian sources that include no meat (i.e., no flesh of an animal). As will be understood, a processed meat product of the present invention will not include any meat in the product when the meat characterizing ingredient of the product is limited to a vegetarian (i.e., non-meat) source. Also useful herein are various meat by-products and organ parts which are also known as variety meats. Especially preferred for use herein are the meats from beef, poultry, pork, seafood and mixtures thereof. The meat or meat characterizing ingredient preferably can comprise from not less than about 10% or about 10% to about 80%, preferably not less than about 30% or about 30% to about 75% of the processed meat. For best results, the meat or meat characterizing ingredient comprises about 50% to about 70% of the meat product.

Meat products of the present invention can optionally include additional ingredients. For example, ice or cooled water, can comprise from about 0.1 to 3% of the formulation. Another optional ingredient is a nonmeat material or filler also referred to in the art as an extender and/or binder. Suitable materials for use as fillers include various grains or “cereal fillers” based upon wheat, rice, corn, barley, etc., vegetable starch, starch vegetable flour, soy flour, soy protein concentrate, isolated soy protein, non-fat dry milk, calcium reduced skim milk, and dried milk. These materials may be used alone or in combination from about 0.1% to 3.5% of the finished product.

Other additional optional materials can include any number of adjuvant materials suitable for enhancing the appearance, nutritional, organoleptic or other attributes of the present processed meat products. Exemplary materials include flavors, colorants, vitamins, and preservatives. If present, such adjuvant materials preferably can each comprise from about 0.01% up to 2% of the product. Condiments such as seasonings and pickling agents preferably can also be added at conventional condiment levels typically ranging from about 0.1% to 3%.

The meat products of the present invention preferably can have a PUFA content such that an individual serving of the meat product has an appropriate amount of PUFA per serving. Appropriate amounts of omega-3 LC PUFA and/or omega-6 LC PUFA per serving are known in the art. Preferred amounts of omega-3 LC PUFA and/or omega-6 LC PUFA per serving include amounts of omega-3 LC PUFA and/or omega-6 LC PUFA between about 5 mg per serving and about 150 mg per serving; between about 10 mg per serving and about 100 mg per serving; between about 25 mg per serving and about 75 mg per serving; and between about 35 mg per serving and about 50 mg per serving.

In preferred embodiments, the meat products of the present invention comprise an antioxidant. If used, an antioxidant can be incorporated into the powder-like substance comprising a powder and an LC PUFA, into a microencapsulated LC PUFA, into the meat product directly, or any combination. Any antioxidant suitable for food oils or fats preservation known in the art is compatible with the present invention, and include vitamin E, butylhydroxytoluene (BHT), butylhydroxyanisole (BHA), tert-butylhydroquinone (TBHQ), propyl gallate (PG), vitamin C (as used herein, reference to vitamin C includes derivatives thereof), phospholipids, and natural antioxidants such as rosemary extract, and combinations thereof. Preferred antioxidants include BHA, BHT, TBHQ, a blend of BHA/BHT, and combinations thereof, and particularly, TBHQ. Amounts of antioxidant to include in the composition will vary depending on the application as determined by one skilled in the art. For example, meat products of the present invention comprising relatively greater amounts of LC PUFAs preferably can contain higher amounts of antioxidant, such as, for example, amounts up to the maximum allowed by current United States law. Antioxidants may be added to or blended with an LC PUFA oil by any method known in the art prior to formation of particles by combination with a powder or microencapsulation. Preferred amounts of antioxidant in the oil component of the powder-like substance of the present invention include amounts between about 0.01% and about 1% by weight of the oil, and between about 0.1% and about 0.5% by weight of the oil.

The meat products of the present invention preferably can be conventionally packaged for refrigerated or frozen storage and distribution or can be canned. However, in preferred embodiments, the meat products of the present invention are stored under appropriate conditions to minimize oxidative degradation. Many methods to effect such storage conditions are known in the art and are suitable for use with the present invention, such as, for example, replacement of ambient air with an inert gas atmosphere. A preferred method by which to reduce or minimize oxidative degradation is to store meat products under a nitrogen (N₂) atmosphere or mixed nitrogen and carbon dioxide atmosphere. Preferably, meat products are packaged under nitrogen. Methods for producing a nitrogen gas atmosphere into a food container are known in the art.

In another embodiment, the meat product of the present invention includes a meat product intended for consumption by infants or toddlers. For instance, snack foods containing ARA are suitable for consumption by children that are still consuming infant formula, but who are also starting to eat solid foods. In some of these embodiments, ratios of DHA:ARA in oils of the present invention are from about 1:0.5 to about 1:5. Additional ratios are at about 1:1.5, at about 1:2 and at about 1:3. The present invention includes a variety of alternative embodiments. In one such embodiment, processed meat products of the invention can be prepared with oils other than oils comprising long chain polyunsaturated fatty acids. For example, such other oils can be oils comprising other nutritional components. In another embodiment, processed meat products of the invention comprising a substrate other than a powder, as described herein, onto which the oil is plated for dispersion in the processed meat product. A still further embodiment is the production of processed food products, other than meat products, comprising a powder-like substance of the present invention. For example, such products can include cheeses, spreads, food bars, etc.

### EXAMPLES

### Example 1

This example illustrates the preparation of plated oil in accordance with the present invention.

Cornstarch as needed for a particular application was weighed out. The cornstarch was added to a DHA-containing oil. Enough cornstarch was added to the oil in order to “plate” the oil onto the powder, until the mixture was not pasty but free-flowing, similar to the starch without the oil. The oil/starch mixture was then added back into the remaining cornstarch. This mixture was blended using an electric mixer (approximately 5-10 sec) until oil plated powder is sufficiently blended into the remaining cornstarch. At that point, additional desired ingredients, such as a vitamin pre-mix, were added to the mix.

### Example 2

This example shows the preparation of beef frankfurters in accordance with the present invention.

Beef frankfurters were formed in the conventional manner. Briefly, selected amounts of beef meat material and water were added together in a mixing or chopping vessel, and coarsely chopped. Plated oil or DHA-containing oil (clear liquid oil or semi-solid oil) was then added, together with any additional desired ingredients such as fillers, flavorings, colorants, and preservatives. Three batches were prepared with the plated oil added to achieve a level of either 50 mg DHA (from DHA-containing clear oil)/45 gram serving, 100 mg DHA (from DHA-containing clear oil)/45 gram serving, or 100 mg DHA (from DHA-containing semi-solid oil)/45 gram serving.

The mixture was then blended for a period of time sufficient to form a homogenous meat emulsion. After the mixture was blended to form a meat emulsion, the meat emulsion was shaped, treated, passed through an extrusion tube, and cut into suitable lengths for frankfurters. The frankfurters were then cooked thoroughly.

### Example 3

This example shows the preparation of chicken nuggets in accordance with the present invention.

Chicken nuggets were formed in the conventional manner. Briefly, chicken breast or other chicken meat was ground. Plated oil or DHA-containing oil (clear liquid oil or semi-solid oil) was then added, together with any additional desired ingredients such as fillers, flavorings, colorants, and preservatives, and mixed to form a homogeneous mixture. Three batches were prepared with the plated oil added to achieve a level of either 50 mg DHA (from DHA-containing clear oil)/45 gram serving, 100 mg DHA (from DHA-containing clear oil)/45 gram serving, or 100 mg DHA (from DHA-containing semi-solid oil)/45 gram serving. The mixture was molded into pieces of roughly square shape. The shaped pieces were dusted with a dry batter mix and coated in a batter. For a batter preparation, dry batter mix was mixed in water under stirring. Subsequently, these battered meat pieces were deep fat fried until cooked throughout. After frying the nuggets were cooled and frozen for storage.

### Example 4

This example shows the preparation of ham loaf in accordance with the present invention.

Ham loaf was formed in the conventional manner. Briefly, pork meat was chopped and added to a mixing vessel. Plated oil or DHA-containing oil was then added, together with any additional desired ingredients such as fillers, flavorings, colorants, and preservatives, and mixed to form a sufficient to form an emulsion. Numerous batches were prepared with the plated oil added to achieve varying levels of DHA/28 gram serving. The emulsion was then stuffed into casings. After cooking, the ham loaf product was ready for consumption.

### Example 5

This example shows the sensory evaluation of a number of products prepared in accordance with the present invention.

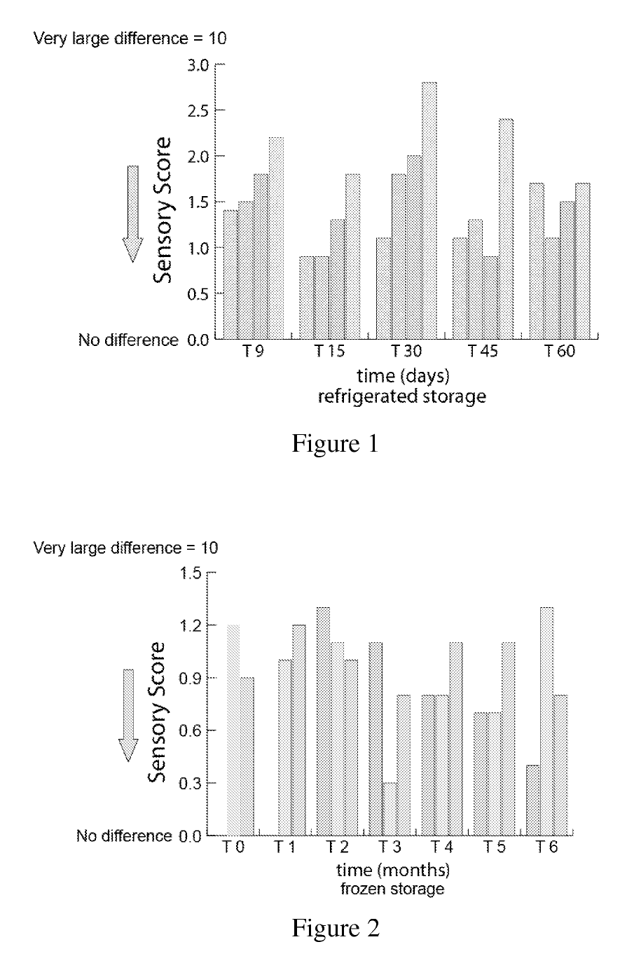

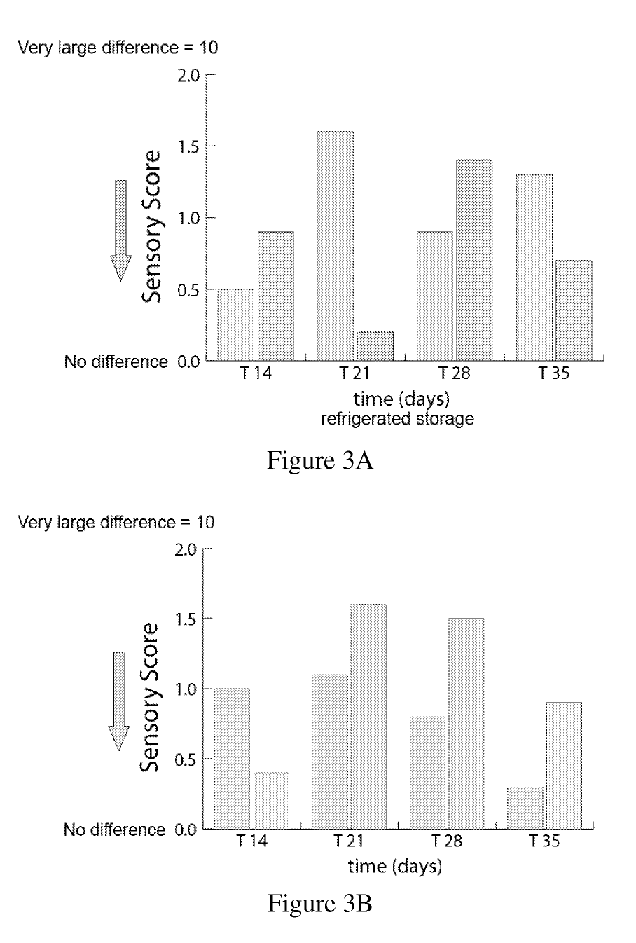

A panel of subjects undertook a “difference from control” sensory evaluation of the processed meats. Panelists were asked to rate the flavor of the various DHA-containing processed meat products on a scale of 1-10, with a sensory score of 1 corresponding to “dislike extremely” and a sensory score of 10 corresponding to “like extremely.” Panelists were also asked to rate a control processed meat product on the same scale. The control score was subtracted from the DHA-containing product score to give the difference from control. A small difference from control score is indicative of a small difference in flavor. For beef frankfurters, a sensory evaluation of the three products was undertaken at 9, 15, 30, 45 and 60 days. The results are shown in FIG. 1. For chicken nuggets, a sensory evaluation of the products was undertaken at 0, 1, 2, 3, 4, 5, and 6 months of frozen storage. The results are shown in FIG. 2. For ham loaf, a sensory evaluation of the products was undertaken at 14, 21, 28 and 35 days of refrigerated storage. The results are shown in FIG. 3A. In addition to a ham loaf control, a sliced ham control was also used as shown in FIG. 3B.

The results in FIGS. 1-3B show that DHA-containing oil can be added to a broad variety of meat products at meaningful levels, while maintaining sensory integrity.

### Example 6

This example illustrates the analysis DHA in meat products of the present invention.

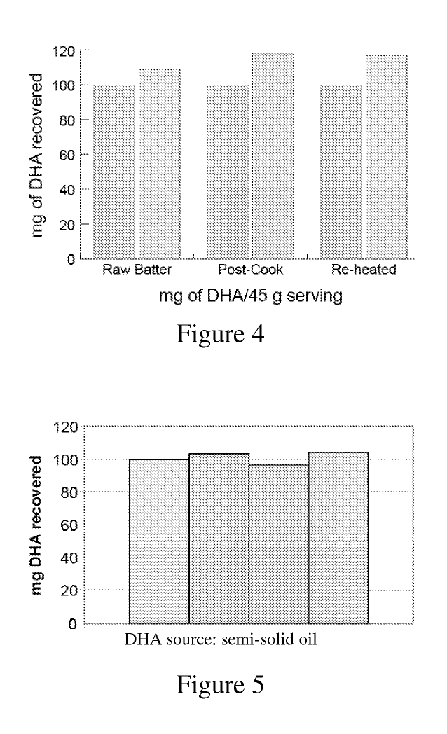

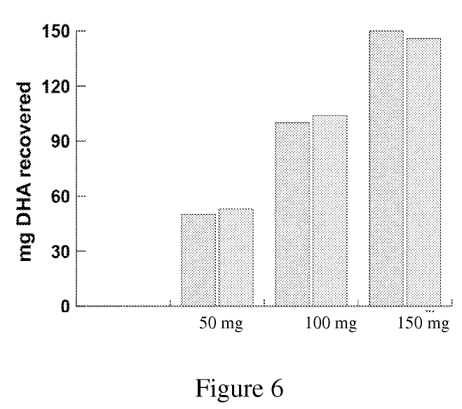

Processed meat samples were dried or extracted with hexane to recover DHA. The samples were processed to prepare fatty acid methyl esters, and were analyzed via gas chromatography. The results are shown in FIGS. 4-6. The results show that DHA-containing oil can be added to a broad variety of foods at meaningful levels and maintain chemical integrity throughout the production of the product. The oil survives a broad latitude of processing conditions used in the food industry.

### Example 7

This example shows the preparation of turkey bologna in accordance with the present invention. Turkey bologna was formed in the conventional manner using the following recipe.

| | | | 50 lb Meat |
|---|---|---|---|
| | | 50 lb Meat | Basis |
| Ingredient | Formula % | Basis (lbs) | (g) |
| Breast Trimmings | 54.69 | 37.5000 | 17025 |
| Thigh Meat | 18.23 | 12.5000 | 5675 |
| Water | 21.88 | 15.0000 | 6810 |
| Opti.Form ® PD4* | 2.55 | 1.7500 | 794.50 |
| Ultra | | | |
| Added Salt | 1.24 | 0.8500 | 385.90 |
| Seasoning | 1.01 | 0.6900 | 313.26 |
| Phosphate | 0.18 | 0.1250 | 56.75 |
| Cure (6.25% nitrite) | 0.18 | 0.1250 | 56.75 |
| Sodium Erythorbate | 0.04 | 0.0273 | 12.41 |
| Total | 100.00 | 68.5673 | 31129.55 |

Briefly, turkey meat (breast trimmings and thigh meat) was chopped and added to a mixing vessel. Microencapsulated DHA-containing oil was added, together with the additional ingredients, and mixed to form a sufficient to form an emulsion. The emulsion was then cooked, after which the turkey bologna was ready for consumption.

The present invention, while disclosed in terms of specific methods, products, and organisms, is intended to include all such methods, products, and organisms obtainable and useful according to the teachings disclosed herein, including all such substitutions, modifications, and optimizations as would be available to those of ordinary skill in the art. The following examples and test results are provided for the purposes of illustration and are not intended to limit the scope of the invention.

1. A processed meat product, comprising a powder-like substance, wherein the powder-like substance comprises an oil comprising a long chain polyunsaturated fatty acid.

2. The processed meat product of claim 1, wherein the long chain polyunsaturated fatty acid is selected from the group consisting of an omega-3 long chain polyunsaturated fatty acid, an omega-6 long chain polyunsaturated fatty acid and mixtures thereof.

3. The processed meat product of claim 1, wherein the powder-like substance comprises a filler selected from starch-based fillers and protein-based fillers.

4. The processed meat product of claim 1, wherein the powder-like substance is a plated oil.

5. The processed meat product of claim 1, wherein the powder like-substance comprises a microencapsulated oil.

6. The processed meat product of claim 1, wherein the meat product is selected from the group consisting of beef products, pork products, poultry products, seafood products and meat analog products.

7. The processed meat product of claim 1, wherein the meat product is a comminuted meat product.

8. The processed meat product of claim 1, wherein the meat product is a sectioned and formed meat formulation or sausage.

9. The processed meat product of claim 1, wherein the meat product further comprises an antioxidant.

10. The processed meat product of claim 9, wherein the antioxidant is selected from the group consisting of vitamin E, butylhydroxytoluene (BHT), butylhydroxyanisole (BHA), tert-butylhydroquinone (TBHQ), propyl gallate (PG), vitamin C, phospholipids, and natural antioxidants, and combinations thereof.

11. The processed meat product of claim 9, wherein the antioxidant comprises TBHQ.

12. The processed meat product of claim 9, wherein the antioxidant is present in an amount of between about 0.01% and about 1% by weight of the oil.

13. (canceled)

14. The processed meat product of claim 2, wherein the omega-3 LC PUFA, omega-6 LC PUFA and mixtures thereof is selected from the group consisting of docosahexaenoic acid, eicosapentaenoic acid, docosapentaenoic acid, arachidonic acid and mixtures thereof.

15. The processed meat product of claim 1, wherein the oil is from a microbial source.

16. The processed meat product of claim 15, wherein the microbial source comprises a microorganism selected from the group consisting of algae, protists, bacteria and fingi.

17. (canceled)

18. The processed meat product of claim 15, wherein the microbial source is a microorganism selected from the group consisting of microorganisms of the genus Thraustochytrium, microorganisms of the genus Schizochytrium, microorganisms of the genus Althornia, microorganisms of the genus Aplanochytrium, microorganisms of the genus Japonochytrium, microorganisms of the genus Elina, microorganisms of the genus Crypthecodinium, microorganisms of the genus Mortierella and mixtures thereof.

19. (canceled)

20. The processed meat product of claim 1, wherein the oil is from a plant source.

21. (canceled)

22. The processed meat product of claim 21, wherein the plant source has not been genetically modified to produce long chain polyunsaturated fatty acids, wherein the plant is selected from the group consisting of soybean, corn, safflower, sunflower, canola, flax, peanut, mustard, rapeseed, chickpea, cotton, lentil, white clover, olive, palm, borage, evening primrose, linseed and tobacco.

23. The processed meat product of claim 1, wherein the oil is from an animal source.

24. (canceled)

25. The processed meat product of claim 1, wherein the oil comprises at least about 20% omega-3 LC PUFAs, omega-6 LC PUFAs and mixtures thereof.

26. The processed meat product of claim 1, wherein the oil comprises at least about 60% omega-3 LC PUFAs, omega-6 LC PUFAs and mixtures thereof.

27. The processed meat product of claim 1, wherein the product comprises between about 5 mg and about 150 mg of omega-3 LC PUFA, omega-6 LC PUFA and mixtures thereof per serving.

28. The processed meat product of claim 1, wherein the powder-like substance comprises less than about 50% by weight of the oil.

29. The processed meat product of claim 1, wherein the powder-like substance comprises between about 10% by weight and about 50% by weight oil.

30. The processed meat product of claim 1, wherein the powder-like substance comprises between about 20% by weight and about 45% by weight oil.

31. (canceled)

32. A process for preparing a processed meat product, comprising incorporating a powder-like substance comprising an oil comprising a long chain polyunsaturated fatty acid into a processed meat product.

33-62. (canceled)

63. A processed meat product, comprising:
a) a meat or meat substitute selected from the group consisting of beef, pork, poultry, seafood, venison, veal, soy derivatives, legumes, mushrooms; and
b) a powder-like substance, wherein the powder-like substance comprises a plant oil comprising a long chain polyunsaturated fatty acid.

64. A processed meat product, comprising:
a) a meat or meat substitute selected from the group consisting of beef pork poultry, seafood, venison, veal, soy derivatives, legumes, mushrooms; and
b) a powder-like substance, wherein the powder-like substance comprises a microbial oil comprising a long chain polyunsaturated fatty acid.

65-80. (canceled)
